(19) United States
(12) Patent Application Publication
(10) Pub. No.: US 2009/0049031 A1
(43) Pub. Date: Feb. 19, 2009

(54) Method And System For Database Searching

(76) Inventor: Neil C. Hepburn, Toronto (CA)

Correspondence Address: HODGSON RUSS LLP;THE GUARANTY BUILDING, 140 PEARL STREET, SUITE 100, BUFFALO, NY, 14202-4040, US

(21) Appl. No.: 11/838,532

(22) Filed: Aug. 14, 2007

(51) Int. Cl. G06F 17/30

(52) U.S. Cl. 707/5; 707/E17.017

(57) ABSTRACT

A method of searching a second database comprising A) receiving a summary document generated by the first database, the summary document comprising a list of returned first database subject keys, representing the returned first database subjects, the list further including at least one identifier associated with the returned first database subjects; B) reading the summary document and generating one or more second database query options for searching for second database subjects that have relationships to the returned first database subjects corresponding to the at least one identifier; C) receiving a second database query in accordance with said one or more second database query options; D) receiving said returned first database subjects; E) using said returned first database subjects, searching said second database in accordance with said second database query options.

### FIELD OF THE INVENTION

This invention relates to the field of information technology, and more particularly, to the field of database searching.

### BACKGROUND OF THE INVENTION

Databases are widely used for the organized storage of information. Part of the value associated with a database comes from the ability to extract subsets of data from the database according to specified search criteria. Thus, for example, it is valuable for a real estate database listing homes for sale to be searchable by various relevant search criteria, such as lot size, number of bedrooms, location, and other criteria typically considered important by home buyers.

In some situations, the information desired by a user is distributed across more than one database. For example, a house buyer may want to know, inter alia, whether houses have restaurants nearby. While the house database of this example may contain much information about houses for sale, it contains no information on restaurants. However, a separate restaurant database may exist with information about restaurants, such as location, type of cuisine, and rating.

Suppose the buyer wants to know about all houses that are (1) in a particular price range, (2) in a particular geographical area, and (3) within a particular distance of an Italian restaurant. Information from both databases is needed to answer this query. Historically, this query could be answered by merging the data from the two databases into a single database, and then searching the merged data.

There are at least two reasons why this traditional approach is problematic. First, merging of databases to permit the searching of the contents of all of the databases is expensive and computationally complex. In many cases, a user will simply do without desired information rather than undertaking the task of merging databases.

Second, particularly in cases where the databases are owned by separate entities, there are security concerns about proprietary data and data-sharing that militate against the merging of databases. Because database information is often valuable, confidential and proprietary, the owner of the database may well hesitate to merge it into a third-party database that it does not control.

Alternatively, each house returned from the search of the real estate database could be entered manually into the restaurant database, one-by-one. However, this approach is extremely labourious and inefficient.

U.S. Pat. No. 6,704,720 (“Arai et al.”) discloses a system for retrieving information from a plurality of databases, even when the content of the databases is different. A target database-extracting device extracts databases containing sought data. An integrated information retrieval device integrates data from the extracted database and retrieves records from the databases matching retrieval conditions. A systematic retrieval device retrieves other records from the extracted databases that are systematically close to the records designated to be retrieved The systematic closeness between records is calculated as a function of the degree of similarity between information in the records. A retrieval result display device displays the results of the retrieval by the integrated retrieval device and by the systematic retrieval device.

Arai et al., while allowing the searching of multiple databases, still requires merging of data from multiple databases. Thus, Arai et al. does not solve the problems of computational complexity and data insecurity associated with database merging.

U.S. published patent application number 2005/0278368 (“Benedikt et al.”) is directed to integrating data from multiple relational sources into a document. A user types a search query into a first server, which rewrites the query into multiple subqueries that are understood by servers 2, 3, 4 etc. Each of these servers executes the individual search associated with each corresponding subquery. Results are sent back to the first server.

Benedikt et al. provides a method for searching multiple databases, but the method is inflexible and complex. The inflexibility stems from the fact that, to search the databases, a single query must be composed. If a supplementary search is required, a new main query is composed for a second search of all the databases, possibly resulting in unnecessary overuse of scarce computational resources.

### SUMMARY OF THE INVENTION

Therefore, what is desired is a method and system for searching multiples database that solves or lessens the severity of the security and computational problems described above. Therefore, according to the present invention, there is provided a method of searching a plurality of databases, including a first database and a second database, the method comprising the steps of:

A) querying the first database with a first query;

B) in response to said first query, receiving a summary document from the first database, the summary document comprising a list of returned first database subject keys, representing returned first database subjects, generated by said first query, said list including at least one identifier associated with said returned first database subjects;

C) moving said summary document to the input of a second database, the second database being configured to receive and read said at least one identifier and generate one or more additional query options for querying the second database for relationships, corresponding to said at least one identifier, between second database subjects and said returned first database subjects;

D) querying said second database with at least one of said additional query options, the second database being configured to receive and consume said returned first database subjects;

E) receiving from said second database returned second database subjects, and information relating said returned second database subjects to said returned first database subjects.

In another aspect of the invention, there is provided a method of searching a second database for second database subjects that relate to returned first database subjects returned from a search of a first database, the method comprising the steps of:

A) receiving a summary document generated by the first database, the summary document comprising a list of returned first database subject keys, representing the returned first database subjects, the list further including at least one identifier associated with the returned first database subjects;

B) reading the summary document and generating one or more second database query options for searching for second database subjects that have relationships to the returned first database subjects corresponding to the at least one identifier;

C) receiving a second database query in accordance with said one or more second database query options;

D) receiving said returned first database subjects;

E) using said returned first database subjects, searching said second database in accordance with said second database query options.

In another aspect of the invention, there is provided a method of conducting a search of a second database that has a second database user interface associated therewith, the method comprising using the second database user interface to perform the steps of:

A) receiving a request from a user to search the second database in accordance with search parameters selected by the user, said search parameters including at least one relationship between subjects returned from a previous search of a first database, and subjects in the second database;

B) requesting the subjects returned from the previous search of the first database;

C) receiving from the first database the subjects returned from the previous search of the first database;

D) uploading to the second database the search parameters, the subjects returned from the search of the first database, and identifiers associated with said subjects, to the second database.

the second database being configured to search in accordance with the search parameters.

### BRIEF DESCRIPTION OF THE DRAWINGS

Reference will now be made, by way of example only, to drawings of the invention, which illustrate the preferred embodiment of the invention, and in which:

FIG. 1 is a schematic diagram of an example system carrying out the method according to the present invention;

FIGS. 2A and 2B are example screenshots of a first database browser window;

FIGS. 3A, 3B and 3C are example screenshots of a second database browser window;

FIGS. 4A, 4B and 4C are example screenshots of a third database browser window;

FIGS. 5A, 5B and 5C are example screenshots of a fourth database browser window, and

FIGS. 6A, 6B and 6b are example screenshots of a fifth database browser window.

### DETAILED DESCRIPTION OF THE PREFERRED EMBODIMENTS

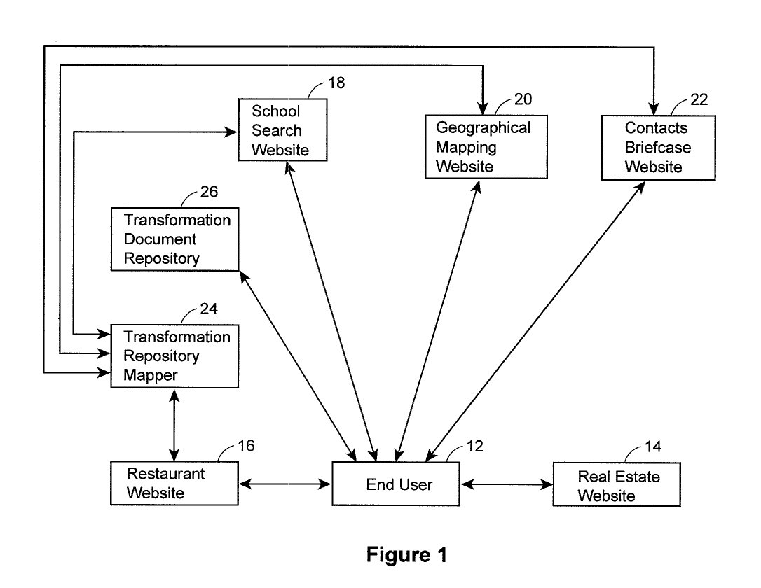

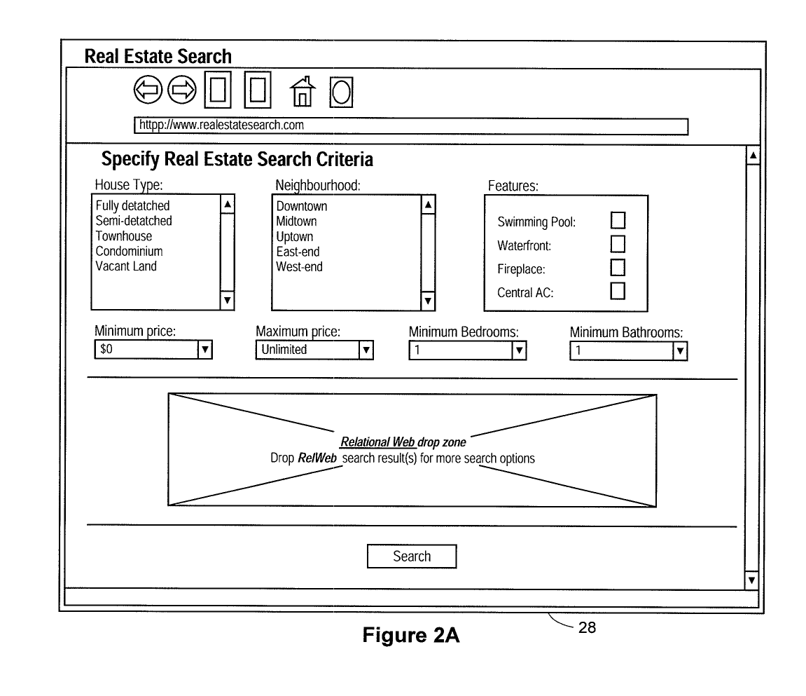

Referring now to FIG. 1, a number of databases and associated elements are shown, together with the operative connections between the elements. FIG. 1 will be used to describe an illustrative example of a method of searching a plurality of databases according to the present invention. In the example of FIG. 1, an end user 12 seeks to search for or save desired information across a plurality of databases, including, a real estate website database 14, a restaurant website database 16, a school search website database 18, a geographic mapping website database 20, and a contacts briefcase database 22. The end user 12 is connected to each of these databases, preferably a corresponding database user interface. Most preferably, the database user interfaces comprise browser windows. The user may optionally be connected to the databases over the internet. It will be appreciated, however, that the invention comprehends other modes of connection between user 12 and the databases. What is important is that the user 12 be able to search at least two of the databases in accordance with the present invention.

Each of the databases 16, 18, 20 and 22 is operatively connected to the transformation repository mapper 24, whose function will be explained in greater detail below. Also, the end user 12 is preferably operatively connected to the transformation document repository 26, whose function will be described in greater detail below. In FIG. 1, the real estate database 14 is not shown as being connected to the transformation repository mapper 24, though such a connection is comprehended by the invention. In the example of FIG. 1, the real estate database 14 is the first to be searched by end user 12, and as will be described in greater detail below, it is not necessary that the real estate website 14 be connected to the transformation repository mapper 24.

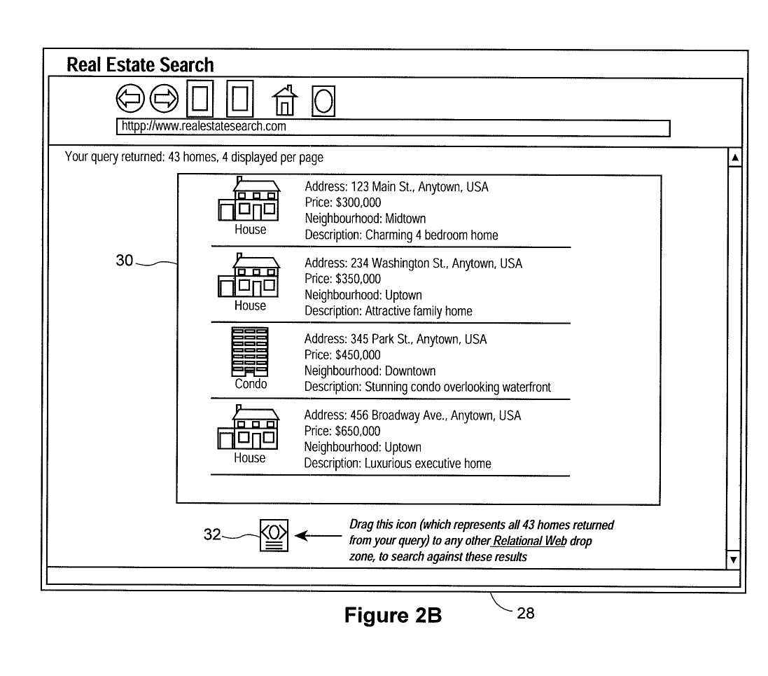

An example search of the databases of FIG. 1, illustrating the method of searching two or more databases according to the present invention, will now be described. In this example, the end user 12 conducts a search for homes using the real estate database 14 through a real estate database browser window 28. An example initial screen shot of real estate database browser window 28 is shown at FIG. 2A. In real estate database browser window 28, various criteria (e.g. house type, neighborhood, features, price, number of bedrooms, number of bathrooms, etc.) are provided, allowing the user to select search parameters and search the real estate database 14 in accordance with those parameters.

In this example, the user 12 specifies his search criteria and initiates the search by clicking the search button at the bottom of the browser window 28. The real estate database 14 conducts the search on the user's behalf, and based on the search query parameters, returns search results in browser window 28. The returned real estate database subjects are shown in FIG. 2B are designated collectively by reference numeral 30. The subjects 30 will have at least one identifier associated with them, and may have more than one, depending on the parameters of the search of database 14.

Preferably, the real estate database 14 returns a real estate search summary document, represented by real estate summary document icon 32. Icon 32 is shown in real estate browser window 28, together with returned real estate database subjects 30. The summary document represented by icon 32 is preferably generated and returned by the real estate database concurrently with the return of the returned real estate database subjects 30. In its preferred form, the real estate database summary document comprises a list of returned real estate database subject keys, each key comprising a number representing each of the returned real estate database subjects 30. The summary document also preferably provides pointers to definitions of the identifiers associated with the returned real estate database subjects 30. Most preferably, the pointers comprise URIs, though the invention comprehends other types of pointers. Thus, in the example of the real estate database 14, each returned subject (i.e. each home) has various identifiers, such as address, price, neighborhood, etc. Other possible identifiers include square footage, type of home (e.g. detached house, townhouse, condominium, etc.). In this example, each database subject 30 returned by the real estate database 14 has multiple identifiers, though the invention comprehends the subjects 30 having at least one identifier.

Preferably, the summary document represented by icon 32 comprises an XML document. XML is preferred because, as will be appreciated by those skilled in the art, all mainstream web browsers (e.g. Internet Explorer™ and Firefox™) contain built-in functionality to easily parse and validate XML-encoded data. However, it will be appreciated that the invention comprehends the summary document being expressed in another, less-preferred form. What is important is that the summary document can be accessed by subsequent databases and/or browsers.

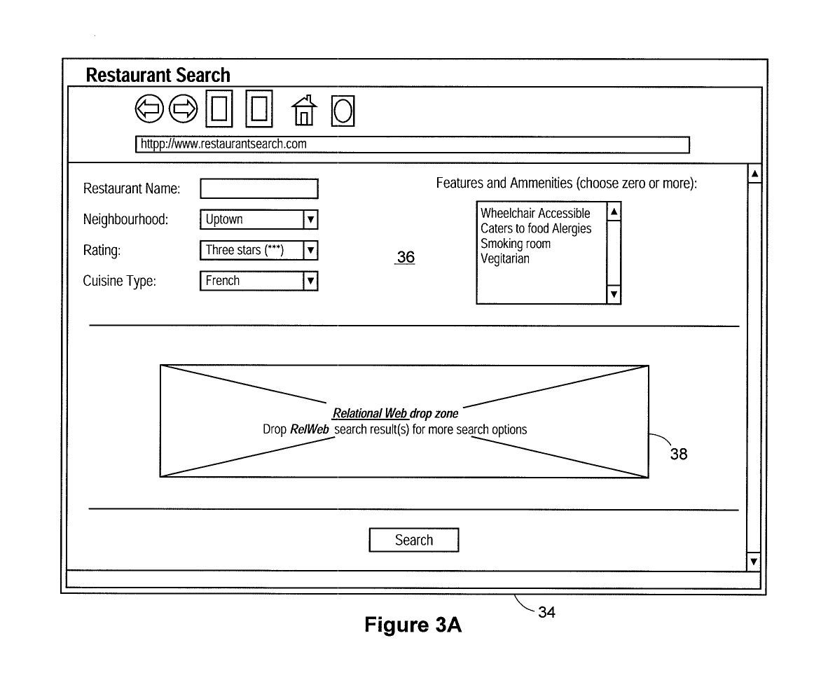

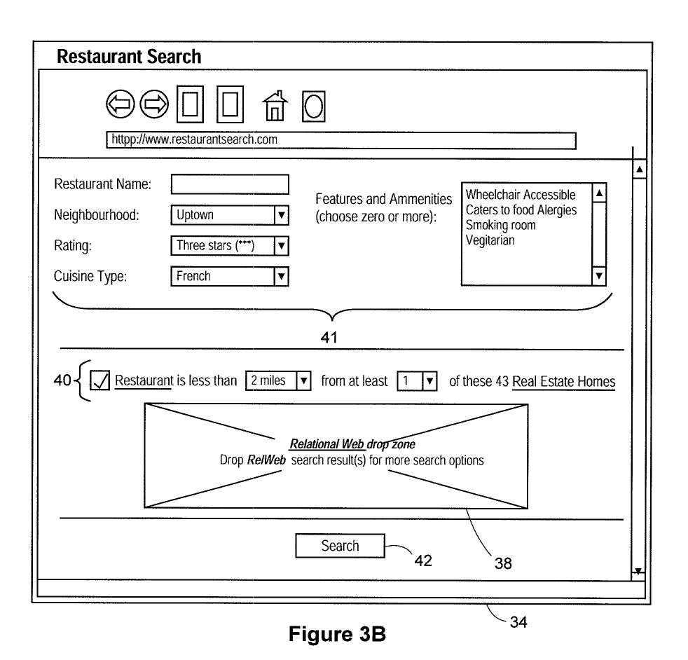

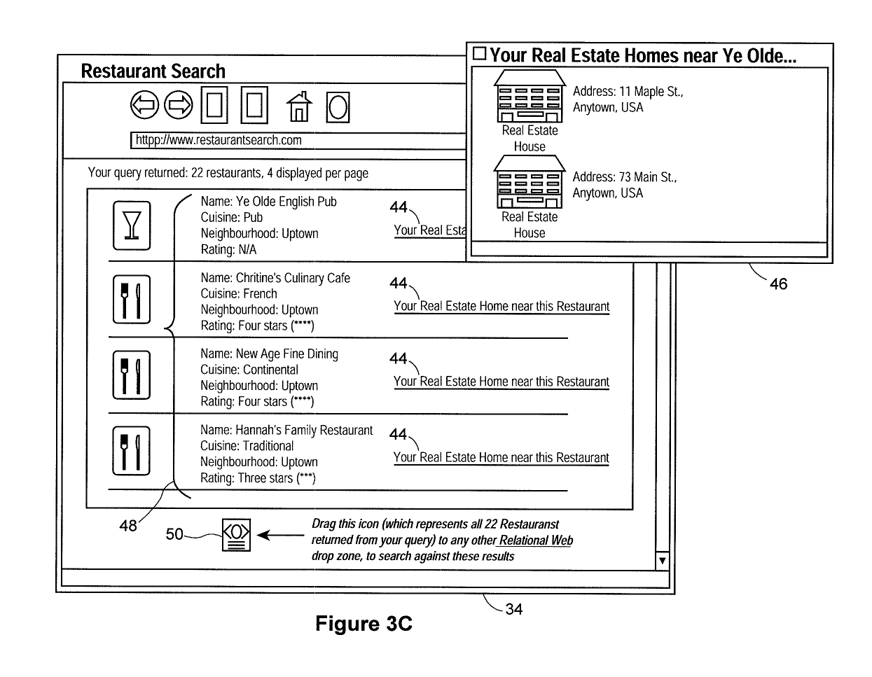

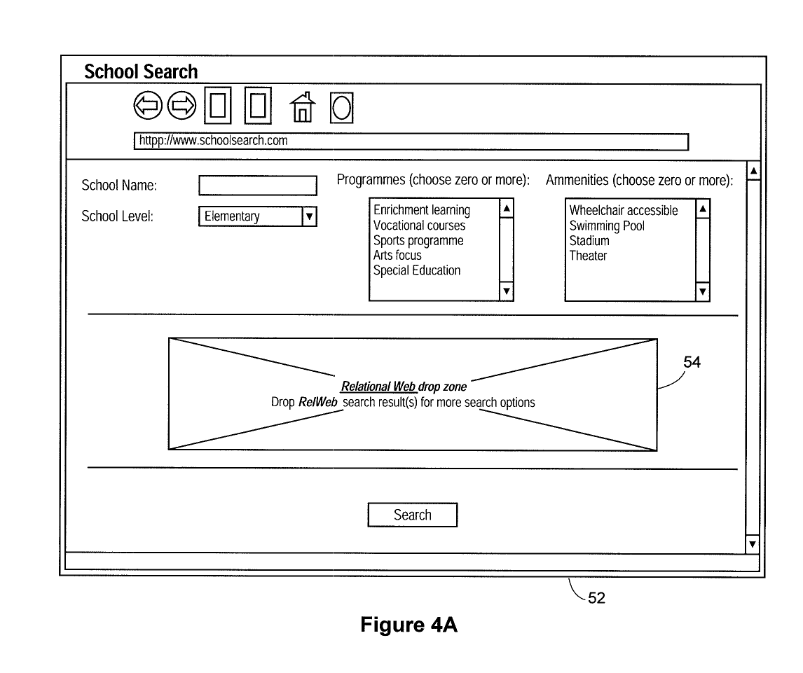

FIG. 3A shows a restaurant database browser window 34 connected to the restaurant website database 16. Within browser window 34 is search query area 36 for searching for restaurants according to various identifiers, including, in this example, name, neighborhood, rating, cuisine type, and features and amenities. Also contained within browser window 34 is a summary document drop zone 38. Drop zone 38 and the summary document represented by icon 32 are used as follows. A user wishing to search for homes searches real estate database 14. In the example real estate database 14 described here, homes can be searched for by location, type of home, features, price, and other identifiers. However, there may be criteria that end user 12 considers desirable in a home which criteria cannot be searched on the real estate database 14. Thus, for example, an end user 12 shopping for a home may enjoy fine French cuisine, and may want to buy a home within a specific distance of a French restaurant. Information relating to the location of such restaurants is not contained on real estate database 14. However, it is contained in restaurant database 16. The present invention, as illustrated by the example of the preferred embodiment, allows the end user 12 to search for homes that fulfil the various criteria that he finds desirable and that are searchable on the real estate database 14, and that also fulfil the desirable criteria that are searchable on the restaurant database 16, but not on real estate database 14.

The use of the summary document represented by icon 32 permits information about the database subjects 30 to be provided to the restaurant database 16. The drop zone 38 comprises a region of browser window 34 in which, when the icon 32 is dragged and dropped in drop zone 38, the browser 34 is prompted to upload the information in the summary document to the restaurant database 16. As will be more particularly described below, database 16 will use the information in the summary document to generate additional query options which allow the user to obtain subjects from the database 16 that relate to the returned database subjects 30.

When the icon 32 is dropped in drop zone 38, the content of the summary document is transferred to the restaurant database browser 34 from the real estate database browser 28 via the browser's inter-browser data exchange mechanism. In the preferred embodiment, in Microsoft™ Internet Explorer™, this data exchange mechanism comprises the “dataTransfer” object, but it will be appreciated that the implementation of the data exchange mechanism could be different and still be comprehended by the invention. What is preferred is that it be possible to exchange data between browser 28 and browser 34 through a user-initiated dragging and dropping action of the icon 32.

Preferably, browser 34 responds to the dropping of icon 32 in drop zone 38 by asynchronously uploading the data in the summary document to restaurant database 16. Preferably, the summary document contains a numerical key representing each of the returned database subjects 30, together with the identifier URIs. The restaurant database 16 parses the summary document, retrieving the data contained in it.

It will be appreciated by those skilled in the art that separate databases, created, configured and owned by separate entities, will often use and understand different identifiers. Therefore, an identifier used and understood by one database may not be recognizable to another database. For example, the number of bedrooms may be defined as an identifier for homes in database 14, but would be unrecognized by database 16. As another example, a property identification number (PIN) may be used by the real estate database 14 to identify properties listed thereon, but would not be understood by restaurant database 16. Alternatively, in some cases, two databases will define a known identifier (e.g. address) in different ways. Taking a specific example, one address definition could require the suite number to precede the street number and be separated from it by a hyphen (i.e. 153-207 Jones Avenue), while another definition could require the suite number to follow the street address (i.e. 207 Jones Avenue, Suite 153). For the purposes of this specification, identifiers that are either unknown to a database, or defined differently from the definition used by that database, will be characterized as “unrecognized.”

In the present example, various identifier URIs contained within the summary document specify the identifier definitions for the real estate database 14, and these identifiers may be unrecognized by the restaurant database 16. For example, there are various different ways to define an address identifier. To determine which of the identifiers from the real estate database 14 are unrecognized by the restaurant database 16, the restaurant database 16 parses through the identifier URIs, reading the definition of each identifier and determining whether it recognizes the definition. Then, the restaurant database 16 places all unrecognized identifier URIs into a transformation repository input document, which document is preferably an XML document. XML is preferred because mainstream browser include functionality to easily parse and validate XML-encoded data, but any other format is comprehended by the invention if the input document can be read, sent and received as needed. This document is used to submit the unrecognized identifier definitions to the transformation repository mapper 24 (through other modes of communicating with mapper 24 are comprehended). The transformation repository mapper 24 functions to determine if there exist any mappings between the unrecognized identifiers and identifiers recognized by the restaurant database 16. For each mapping that is found, the transformation repository mapper 24 returns a URI to a transformation document, along with the original pairing of unrecognized-to-known identifier. The mapping URIs, together with the pairing of unrecognized and known identifier, is preferably contained in a transformation repository mapper output document, which document is preferably an XML document.

The transformation repository mapper output document, listing the URIs for available transformation documents, is returned to the restaurant database 16. The previously recognized identifier URIs and the unrecognized identifiers for which transformation documents are available comprise for the restaurant database a set of usable identifiers for generating additional query options for querying the restaurant database 16. These additional query options permit user 12 to search for relationships, corresponding to the set of usable identifiers, between subjects in the restaurant database 16, and returned database subjects 30.

After generating the additional query options using the set of usable identifiers, the restaurant database 16 sends back to the browser 34 an XML document containing HTML code to render new search options in addition to the search options already available from the restaurant database 16. The additional query options are shown in an additional query option zone 40. In this example, both the restaurant database 16 and the real estate database 14 recognize (possibly by means of a transformation document) the address identifier. Thus, restaurant database 16 is configured to use the address identifier to offer an additional query option allowing the end user 12 to limit his search to restaurants within a specified distance of the homes that comprise the returned database subjects 30.

In the preferred embodiment, if appropriate, one or more of the additional queries may include choices for the user. So, for example, the additional query shown in additional query zone 40 allows the user to search for restaurants that are less than X miles from at least Y of the forty-three returned database subjects 30 from the real estate database 14. Specific values for variables X and Y are selectable from drop-down menus. Thus, the user 12, in the present example, can determine not only how many of the restaurants that fit his other criteria are in a particular distance from at least one of the homes; the user can also locate the homes that have the greatest number of restaurants within his chosen proximity. In addition, the query option gives the user the ability to choose a particular proximity. The user in the present example has chosen two miles, but the restaurant database can provide a variety of distances to be chosen by the user 12 (such as, for example, 0.5 miles, 1, 2, 3, 4, 5 miles etc.).

It will be appreciated that databases 14, 16, 18, 20 and 22 can be configured as desired to generate additional query options, and the invention comprehends a variety of ways of doing so. In the present example, the user 12 was provided with a choice within the additional query options. Such a choice is not required by the invention, though it may be preferred in some circumstances. What is important is that additional query options be generated for querying the database 16 for relations between the subjects of database 16 and returned database subjects 30.

In the preferred embodiment, the restaurant database 16 generates the additional query options and presents those query options to the user 12 in the browser window 34, and in particular, in the additional query zone 40. Preferably, when the restaurant database 16 sends the additional query options to the browser 34, it also sends the transformation document mappings (i.e. information connecting an untransformed identifier to the corresponding transformed identifier) originally obtained from the transformation repository mapper 24 back to the browser 34, together with the transformation document URIs. It will be appreciated, however, that, preferably, any transformation document URIs and associated mappings are not sent by the restaurant database 16 to the browser 34 if they do not correspond to any the additional query options presented in the zone 40.

In the preferred embodiment, the browser 34 a synchronously receives the additional query options (as well as the transformation document mappings and URIs) from the restaurant database 16, parses the XML document in which the additional queries are rendered, and presents new search options as new elements on the restaurant search form, and in particular, in the zone 40 of window 34.

At this stage, user 12 may conduct a search on the restaurant database 16. He can use both the search tools 41 originally presented by the restaurant database 16 in window 34, and the additional query options provided in zone 40. Thus, for example, as shown in FIG. 3B, the user may search for all uptown French restaurants having a three-star rating that are within two miles of at least one of the houses contained within the returned database subjects 30 from the real estate database 14. In the preferred embodiment, the search is initiated by clicking the search button 42 in window 34.

In the present example, the additional query options (through which relationships between the returned database subjects 30 and the subjects in the restaurant database 16 are queried) use the address identifier to determine whether any of the returned database subjects 30 relate, according to the query chosen by the user 12, to any of the subjects in the restaurant database 16. Furthermore, in this example, the address identifier as defined in the real estate database 14 was unrecognized by the restaurant database 16, and a transformation document URI was thus obtained from the transformation repository mapper 24. Since the browser 34 has the URI of the required address transformation document, the browser 34 requests the transformation document from the transformation document repository. In the preferred embodiment where internet browser windows are being used to access the databases, the XSLT engine of the browser 34 will preferably be used to apply the transformation document obtained from the transformation document repository 26 to the addresses of the returned database subjects 30 from the real estate database 14 to transform those addresses.

It will be appreciated that, though FIG. 1 shows a single transformation document repository 26, the invention comprehends a system with multiple repositories 26, and multiple mappers 24, according to the needs of users 12 and the circumstances in which the databases operate. It will further be appreciated that, in a situation where there are multiple repositories 26, multiple requests for transformation documents will be required.

Furthermore, in the present example, only one transformation document is required, as there is only one identifier requiring transformation, namely, the address identifier. However, the invention comprehends the presence of multiple unrecognized identifiers, the generation of search options requiring the transformation of multiple identifiers, and therefore, the use of multiple transformation documents. In such a case, the browser 34 would request multiple transformation documents, rather than just one.

It will be appreciated that the invention comprehends a system and method that do not include repository 26 and mapper 24 though such an embodiment is much less preferred. Rather, the invention could function with two or more databases, with transformations. In such an embodiment, the databases would not be able to generate additional query options based on unrecognized identifiers, and would instead be limited to recognized identifiers.

As described above, the summary document dragged and dropped into drop zone 38 preferably contains a list of subject keys, with each key corresponding to one of the returned database subjects 30. It further includes a list of identifiers associated with the returned database subjects 30. Of those identifiers, some are initially unrecognized by the restaurant database 16, and transformation document URIs are sought from the transformation repository mapper 24 in relation to these identifiers. Then, additional query options are presented to the user 12, and the user 12 initiates a search of the restaurant database 16. This search, depending on the specific parameters selected by the user, may require some or all of the transformation documents whose URIs were returned by mapper 24. Therefore, once the search of the restaurant database 16 is initiated by user 12, the browser 34 requests the transformation documents using the URIs received from the mapper 24. In addition, the returned database subjects 30, together with all of their identifiers, are requested in full from the real estate database 14 by browser 34.

It will be appreciated that, until the search of the restaurant database 16 is initiated, and it is known what the parameters of this search will be, the full data associated with the returned database subjects 30 in the real estate database is not extracted or requested. This approach produces certain benefits. First, the real estate database 14 and restaurant database 16 can both be searched without the merging of the databases. Rather, only the returned database subjects 30 are uploaded to the restaurant database 16. This avoids the need for merging of the restaurant database 16 and real estate database 14, which in turn produces both computational and security benefits. The computational benefit is that avoiding merging of the databases sharply reduces the computational complexity associated with the search, in that database merging uses substantial computational resources. Second, database merging produces security risks, in that the proprietor of data in a database may lose exclusive control of the merged data, possibly entailing a loss of data confidentiality. In the preferred embodiment of the present invention, only the returned database subjects 30 are uploaded to the restaurant database 16, so the proprietor of the real estate database 14 does not incur any elevated risk of harm to its data.

In response to the search being initiated, the browser 34 requests transformation documents from the transformation repository 26, and also requests the returned database subjects 30, together with all identifiers associated therewith. In response to these requests, the repository 26 returns the required transformation documents, and the real estate database 14 returns the actual database subjects 30 and associated identifiers, which data is a subset of the data referenced in the summary document represented by the icon 32.

Once the browser 34 receives the transformation documents from repository 26, and the data (including subjects and associated identifiers) from real estate database 14, the browser 34 applies the received transformation documents to the identifiers just received from database 14. In the present example, this involves applying an address transformation document to the address identifiers associated with the returned database subjects 30 to produce new address identifiers recognizable to the restaurant database 16. The subject identifiers from the real estate database 14 that are recognized by the restaurant database 16 are left as is, and for the unrecognized identifiers, new identifiers are generated via the transformation document(s) and attached to the record associated with each real estate database subject 30 that has been requested by the browser 34. In the preferred embodiment, the transformation document is applied by the XSLT engine contained within the browser 34, though other methods of applying the transformation document(s) are comprehended by the invention.

The data received by the browser 34 from the real estate database 14, together with attached transformed identifiers, are then uploaded to restaurant database 16, along with the specific query parameters defining the search of the restaurant database 16 that was initiated by the user 12. Preferably, a session identifier associated with this particular search of the restaurant database 16 is also uploaded to the database 16.

Having received the data (i.e. returned database subjects 30, associated untransformed and transformed identifiers), the restaurant database 16 then performs the search according to the specific query parameters that it uploaded from the browser 34. The search is performed against the data in the restaurant database 16, and the data just uploaded by the restaurant database 16 from the browser 34.

Once the restaurant database 16 completes the search, it returns the search results to the browser 34 in the form of returned restaurant database subjects 48. Preferably, subjects 48 are returned in the form of a viewable HTML document. Most preferably, each subject 48 is associated with a hyperlink 44 positioned nearby, which hyperlink activates a pop-up window 46 showing all of the returned database subjects 30 from the real estate database 14 that are related to the particular returned restaurant database subject 48 through the query parameters. This preferred feature is shown in FIG. 3C.

It will be appreciated that the uploading of data to the restaurant database 16 presents a security risk to the restaurant database 16. Specifically, the data being uploaded to the database 16 could be too voluminous, thus overwhelming the computing resources of the restaurant database 16, and denying those computing resources to other tasks. The, overwhelming of a database's computing resources intentionally or maliciously is commonly referred to as a denial of service (DOS) attack. The preferred form of the present invention includes features that mitigate this risk. First, in the preferred embodiment, it is the browser 34 that requests the data from the real estate database 14, with the result that the returned database subjects 30 are not delivered directly to the restaurant database 16. Rather, the returned database subjects 30 are transmitted to the browser 34, which functions as the interface between the user 12 and the database 16. The browser 34 acts as a protective computing layer between the database 16 and external computers.

Second, preferably, the databases using the method described herein, including the databases 14 and 16, produce data in a tabular format. It will be appreciated by those skilled in the art that, in many applications, it is preferred to have databases produce data in tree or graph formats; these formats are generally considered to be superior to tabular format, on the grounds that tree and graph data structures are considered to be more flexible in their representation of data. However, in the context of the present invention, it has been discovered that producing search results in a tabular format is preferred. One reason for this preference is that, when data is produced in a tabular format, the amount the table is predictable and known. This is to be contrasted with tree or graph data structures, where the amount of data is much less predictable, and less easily determined. As explained above, security is a serious concern in a situation, such as this one, where a database such as database 16 is uploading data originating from an unrelated source such as database 14.

Thus, in the present example, when the browser 34 receives the returned database subjects 30 from the database 14, and the subjects 30 are in tabular format, the quantity of data to be processed, and the time required to process it, can be accurately and easily determined prior to the database 16 loading and processing the data. The browser 34 in turn communicates with the database 16, providing it with information about the amount of data associated with the returned database subjects 30. The database 16 is programmed to receive this information and either accept the returned database subjects 30 and associated identifiers, in which case they are uploaded to database 16, or reject them, in which case they are not uploaded. The database 16 may be programmed to reject the data if, for example, there is too much data and the database 16 may have its computing resources overwhelmed, or diverted to an unacceptably high degree from other tasks.

It will be appreciated by those skilled in the art that a tabular format is also convenient for presenting the results of the search of the restaurant database 16. When the restaurant database 16 uploads the search results from the real estate database 14 in tabular form, and performs the search in accordance with the query submitted by the user 12, the results of the search of database 16 will indicate the relationships, if any, between returned database subjects 30 and the subjects stored in database 16. Because the data uploaded to the database 16 is already in a table, the results of the search of the database 16 are preferably formatted in a join table that shows the relationships between the database subjects 30 and subjects in the database 16 that are found in the search of the database 16. The join table is preferably formed by adding one or more rows/columns to the table so that the relationships between subjects 30 and subjects in the database 16 are shown. Thus, for example, as explained above, it is preferred that hyperlinks 44 activate pop-ups 46 that show all of the subjects 30 that are related to the restaurant associated with the hyperlink. The information for the pop-up window 46 is preferably obtained by means of the browser 34 consulting the join table returned by the restaurant database 16 after the search, and displaying the houses shown in the join table to be associated with each restaurant Also, preferably, the database 16 returns a returned first database subject table (in this case, a house table) showing the data as it relates to each returned house 30, and a returned second database subject table (in this case, a restaurant table), showing the data as it relates to each returned restaurant.

Preferably, the restaurant database 16 produces a restaurant database summary document summarizing the restaurant database search results. The restaurant database summary document preferably lists the restaurant database subjects 48, most preferably by listing the subject key associated with each subject 48. The restaurant database summary document preferably further shows the relationship between returned restaurant database subjects 48 and returned real estate database subjects 30. Preferably, the browser 34 generates restaurant database summary document icon. 50, which represents the restaurant database summary document, and which can be dragged and dropped to another database in the same manner as icon 32.

In the present example, user 12 may wish to further narrow his search for a home according to the school district in which a potential home is located, or according to the proximity of the potential home to particular desired schools. To further refine his search, the user 12 drags icon 50 to summary document drop zone 54 within school search database browser 52, which browser 52 is associated with school search database 18. Once icon 50 is dragged to drop zone 54 and dropped there, browser 52 receives the restaurant database summary document, preferably in the same manner as described above in relation to the browser 34 receiving the real estate database summary document. The restaurant database summary document is then uploaded to the school search database 18, which parses this document and retrieves all subjects listed therein (i.e. homes and restaurants related to those homes). The respective identifier URIs are also retrieved.

As described above in relation to the restaurant database 16, the school search database 18 enumerates all unrecognized subject identifiers, and places their URIs into a transformation repository mapper input document, which document is then uploaded to the transformation repository mapper 24. The mapper 24 parses and processes the transformation repository mapper input document, determining if there exist any mappings between the restaurant and home unrecognized identifiers on the one hand, and the known identifiers of the school search database 18 on the other hand. For each mapping that is found, a transformation document URI is returned by mapper 24, along with the pairing of unrecognized-to-known identifier. Preferably, this information is returned by mapper 24 in a transformation repository mapper output document, preferably in the form of an XML document, which document is returned to the school search database 18.

Having received the transformation repository mapper output document, the school search database 18 examines the union of all known identifiers with all unrecognized identifiers that have transformation documents associated with them, and can thus be converted to known identifiers. The database 18 creates an enumerated list of possible identifiers against which a user can query the school search database 18.

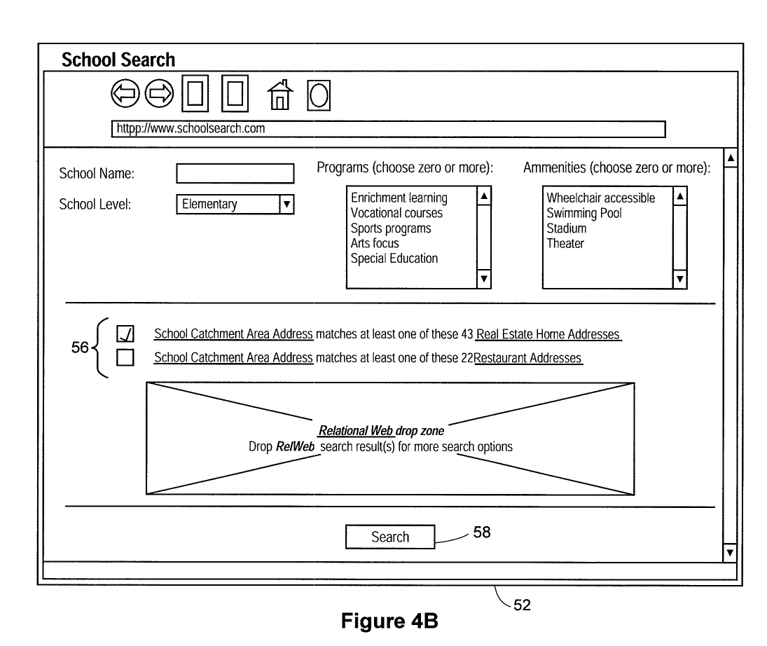

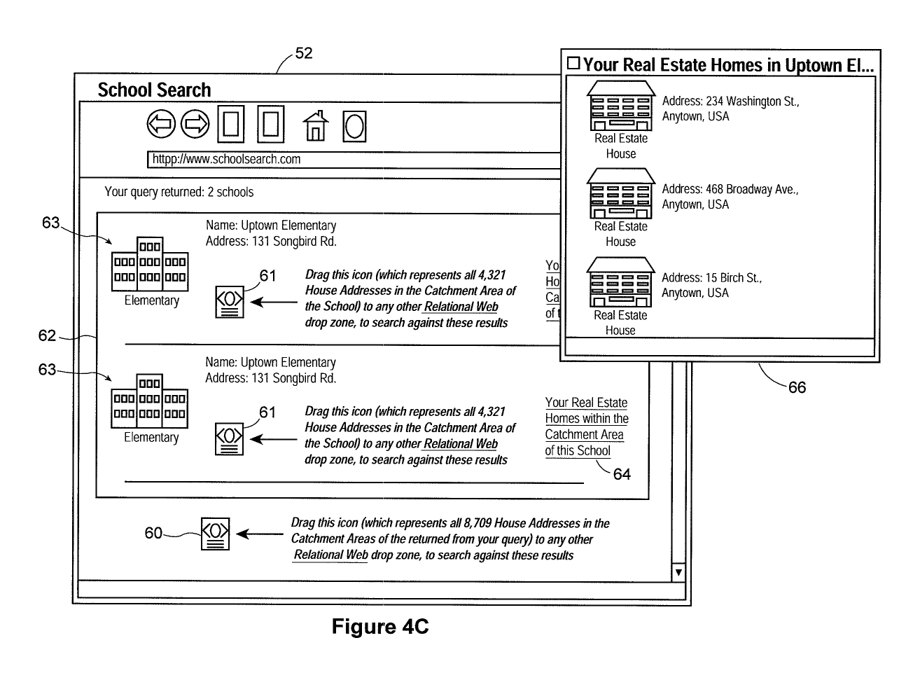

Based on the list of possible identifiers to query against, the school search database 18 generates additional query options and sends those additional query options to the browser window 52 so that the additional query options are presented in that window. Preferably, the additional query options are sent to the browser 52 in the form of an XML document containing HTML code to render additional search options in an additional query option zone 56 in browser 52. In the example shown in FIG. 4B, one additional query option is “school catchment area address matches at least one of these 43 real estate home addresses.” The other is “School Catchment Area Address matches at least one of these 22 Restaurant Addresses.” As shown in FIG. 4B, the user 12 has selected the first additional query, which means that all of the schools returned by the school search database 18 will have catchment areas that contain one of the forty-three returned database subjects 30 from the real estate database 14.

The additional query options generated by school search database 18 are presented in browser 52, and in particular, in additional query option zone 56. Notably, in the present example, only an additional query relating to a relationship between schools and homes is selected. As the second additional query option is not selected, database 18 will not search for any relationships between schools and restaurants.

At the same time as the additional query options are sent, the database 18 sends to the browser 52 the required transformation document mappings, and transformation document URIs. Browser 52 preferably a synchronously receives this information from the school search database 18, and parses the HTML code contained within the XML document. The browser 52 renders the additional query options in the additional query option zone 56 in browser window 52.

With the additional query options now presented, user 12 conducts a search of the school search database 18, using the new controls presented to him in browser window 52. In the present case, the user 12 is provided with the option of checking the additional query options shown in FIG. 4B, or not. Having selected the first one, he will receive information from school search database 18 that relates school catchment area to the individual homes that form the returned database subjects 30 of real estate database 14. To initiate the search, the user will click on the preferred “search” button 58 in browser 52.

In the present example, the selected additional query option shown in zone 56 does not require a transformation. The real estate database address identifier was transformed prior to the search of the restaurant database 16. In the present example, the school search database 18 understands the address identifier definition of the restaurant database 16, and no further transformation is required.

In response to the search being initiated, the browser 52 requests data from database 16 to allow database 18 to search for relationships in accordance with the additional query options. Restaurant database 16 returns the required data as requested by browser 52. Preferably, the database 16 returns the requested data in the form of a join table, which join table shows, inter alia, the relationships between previously returned home subjects, and previously returned restaurant subjects. It will be appreciated that, because the restaurant subject relates to homes being search, the content of the returned restaurant identifiers are also returned by the restaurant database 16. Furthermore, as stated above, no transformations are required by the school search database 18, and therefore, no transformation document URIs are returned.

Preferably, only the real estate homes that were found by the search of the restaurant database 16 to relate to restaurants are returned by the restaurant database 16 to browser 52 at this point. Non-relating real estate homes are preferably not returned. It will be appreciated that databases 16 and 18, and browser 52, are preferably configured in this manner because the purpose of the present invention is to permit the searching of multiple databases to find relationships among the subjects in each database. Thus, if a user wanted to find relationships between all of the returned database subjects 30 and schools listed in the school search database 18, that user would simply drag summary icon 32 from real estate browser 28 to directly drop zone 54 of school search browser 52, skipping over browser 34 and restaurant database 16. If the user did this, then the school search website 18 would upload the associated summary document relating to the search of the real estate database 14, and parse it in the same manner as was done by the restaurant database 16 in the example given above. The school search database 18 would then offer additional query options to allow user 12 to find relationships between schools and homes found in the search of real estate database 14, without regard to the relationship between homes and restaurants. However, since the user has dragged the summary document from restaurant database 16, and dropped it in drop zone 54 of browser 52, it is assumed that the user only wants to find relationships between the schools in the school search database 18 and homes returned in the search of the restaurant database 16 (i.e. homes that relate to the restaurants in the restaurant database 16 according to parameters of the search done by user 12 of database 16).

The browser 52 receives home, restaurant and join data from database 16, and this information is uploaded to school search database 18. The join table shows the relationships between the subjects in databases 14 and 16. Thus, the join table returned by restaurant database 16 shows relationships between homes and restaurants. The join table is then supplemented by the school search database 18 to show the relationships being searched by the user 12. In this case, the relationships to be shown are those between the schools and homes.

Once this data is uploaded to the school search database 18 together with the join table, the school search database 18 conducts a search based on the query parameters selected by the user. Search results are then returned to the browser 52, as shown in FIG. 4C. As shown in FIG. 4C, school search result zone 62 shows each of the returned schools 63 that matches the search parameters selected by the user 12. When the user 12 puts his mouse over a link 64 associated with each returned school 63, a pop-up window 66 appears showing each house returned by database 16, together with its address, that is related to the particular school.

Preferably, the school search database 18 is configured to provide a summary document representing all of the house addresses within the catchment area for each school. These summary documents are represented by icons 61, with one icon being associated with each school. In the preferred embodiment, this icon can be dragged to the drop zone of any database to permit additional searching options. Also, preferably, school search database 18 produces a summary document, represented by icon 60, which represents all of the house addresses in the catchment areas of all schools 63 returned by the search of database 18. As can be seen in FIG. 4C, all of the addresses represented by all of the icons 61 are collectively present in the summary document represented by icon 60, in the preferred embodiment.

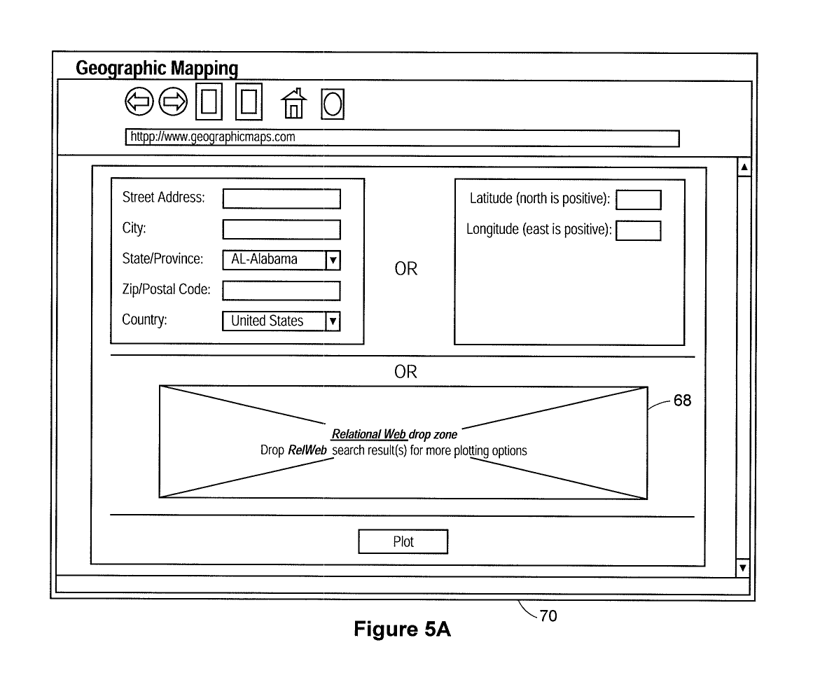

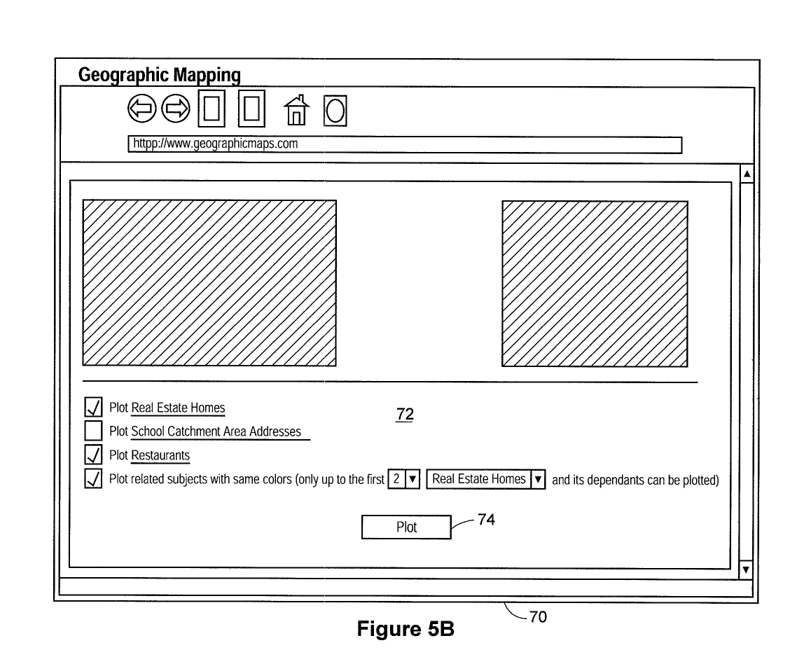

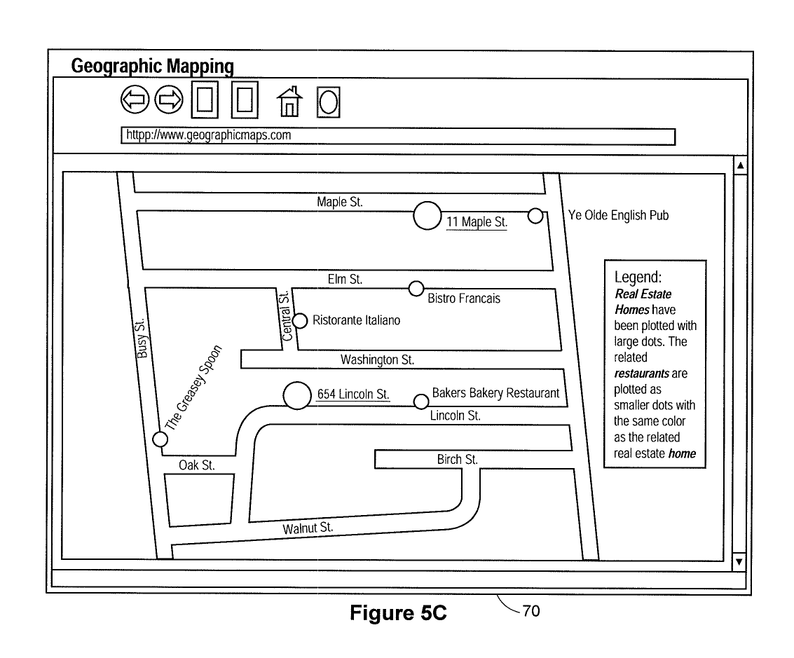

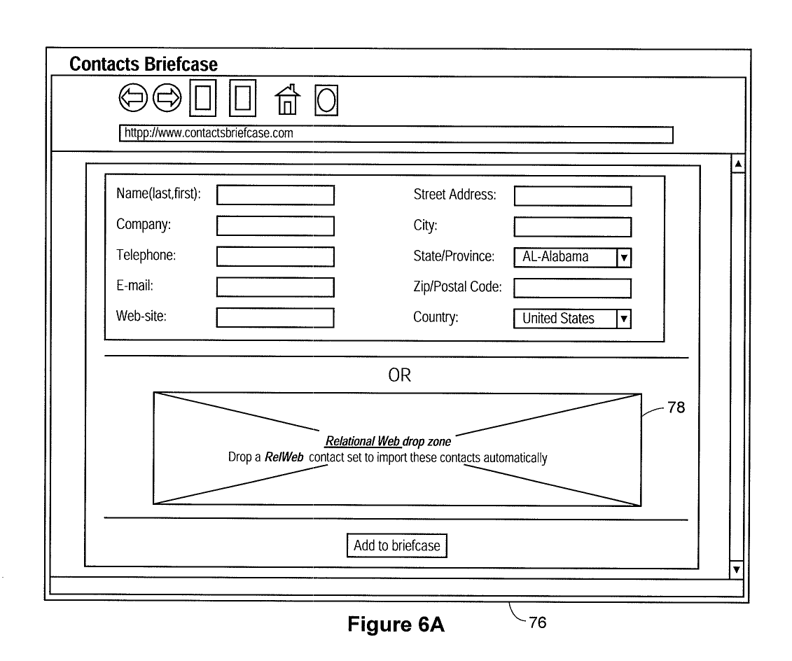

Referring now to FIG. 5A, the user drags icon 60 to the icon drop zone 68 located in browser window 70. Browser window 70 is associated with a geographic mapping database 20. Database 20 allows the user to enter an address, or a latitude and longitude, and a map is produced showing the location of the point entered by the user 12. In the present case, the school search website 18 has returned all of the addresses contained within the school catchment areas of the two schools whose catchment areas include houses returned by the database 16. Therefore, the user may wish to use the geographic mapping database 20 to visualize the two school catchment areas that are of interest, based on the results of the search of school search database 18.

Thus, as with previous databases, the geographic mapping database 20 parses the summary document associated with icon 60, and retrieves all subjects (real estate homes, restaurants and schools) and their respective identifier URIs (e.g. URIs for home address, real estate home listing ID, restaurant address, school address). The geographic database 20 enumerates all unrecognized subject identifiers, and places their URIs into a transformation repository mapper input document, which document is uploaded to the transformation repository mapper 24. The transformation repository mapper 24 parses and processes the input document, determining if there exist any mappings between the unrecognized identifiers from databases 14, 16 and 18, and the known identifiers of geographic mapping database 20. For each mapping that is found, a URI transformation document is returned, along with the original pairing of unrecognized-to-known (i.e. known by database 20) identifier. A transformation repository mapper output document is then returned to database 20, containing this information.

Database 20 receives the transformation repository output document, and examines the union of all known identifiers with all unrecognized identifiers that have transformation documents associated with them (and can thus be converted to a known identifier). The database 20 creates an enumerated list of possible identifiers against which a search can be conducted. Based on the list of possible identifiers to query against, the database 20 sends to browser 70 a document, preferably in XML format, which preferably contains HTML code to render additional query options against the pre-existing search options of database 20. The additional query options are preferably shown in additional query option zone 72, shown in FIG. 5B. Because of the unique nature of the geographic mapping website, namely, that it functions simply to plot locations that are entered, the additional query options, when presented, block the functioning of the pre-existing search options.

In the present example, as shown in FIG. 5B, the user 12 is given the option to (1) plot real estate homes; (2) plot school catchment addresses; (3) plot restaurants; and (4) plot related subjects with the same colors, with only up to the first X subjects to be plotted. Options (1), (2) and (4) have been selected by user 12 In the last additional query option, the user is permitted to select the number and type of subject from a drop down menu. Notably, these plotting options are provided in relation to subjects that have emerged from the searching of databases 14, 15, and 16. Therefore, the real estate homes that may be plotted according to these additional query options are the homes that were shown by the search of database 18 to be related to the schools. Meanwhile, the restaurants to be plotted here are those that were shown by the search of database 16 to be related to homes that were returned by the search of school search database 18.

In the example shown in FIG. 5B, user 12 has chosen to plot the real estate homes, the restaurants, and to plot related subjects with the same colors so that only up to the first two real estate homes and its dependents can be plotted. The results are shown in FIG. 5C. Thus, this use of the geographic mapping database 20 permits the user 12 to visualize the geographic relationships between restaurants that were returned by the search of restaurant database 16, and homes that met the criteria of the searches conducted of databases 14, 16 and 18. User 12, in declining to plot a map of school catchment addresses, has decided not to view the school catchment areas. Rather, having learned from the search of the school search database 18 that certain homes are within the school catchment areas of certain schools, the user 12 may require only a map showing the proximity between those homes and related restaurants.

Referring back to FIG. 5B, the browser 70 receives the additional query options from database 20 and presents them in zone 72. The user 12 can select which of the additional query options he will include in the search, preferably by checking the box associated with each additional query option. The user 12 then initiates the search of the geographic mapping database 20 by clicking the button 74 marked “Plot.” The geographic mapping database 20 receives the query from browser 70 as submitted by user 12, and searches its database to produce a map, with plotted locations, as shown in FIG. 5C.

In the present example, the database 20 recognizes all relevant address identifiers. Therefore, no transformations are required. Once the search query is submitted by user 12 by clicking on button 74, the browser 70 requests home and restaurant subjects, together with associated identifiers, from the school search website 18. Since schools are not being visualized in the mapping operation initiated by the user, school data is not requested from the school search database 18. The. database 18 returns the required data to browser 70, together with a join table. Since the school subject relates, the content of its identifiers is also returned as part of the join table. Furthermore, because the data is being requested from the school search database 18, only the homes and restaurants that relate to returned schools are sent to the browser 70 for uploading to the geographic mapping database 20. Non-relating homes and restaurants are not returned.

Once database 20 receives all of the subject data, including identifiers and join table, it plots the data on the map using mapping parameters and uploaded subject data. The plotted map is returned to browser 70 (as shown in FIG. 5C), and user 12 can now view homes and restaurants on a geographic map.

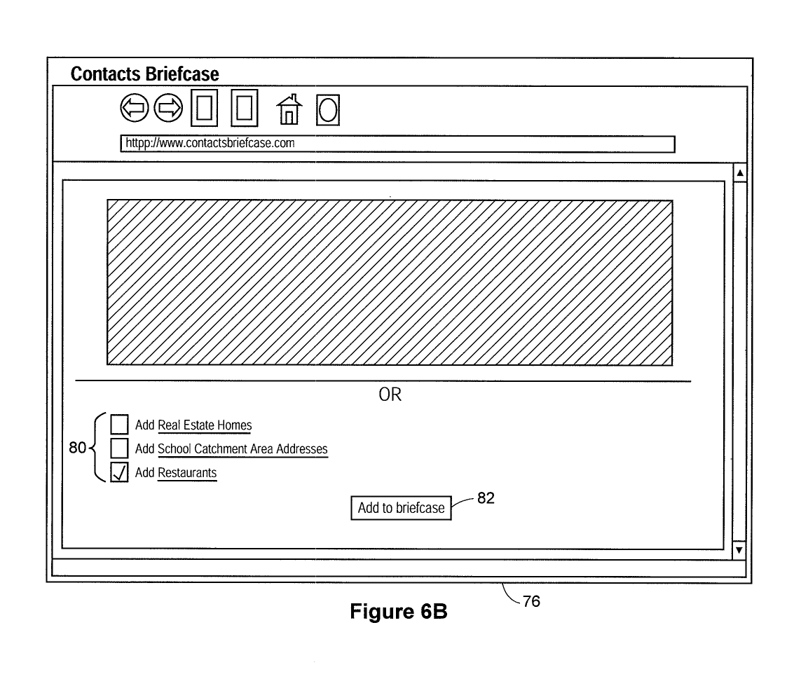

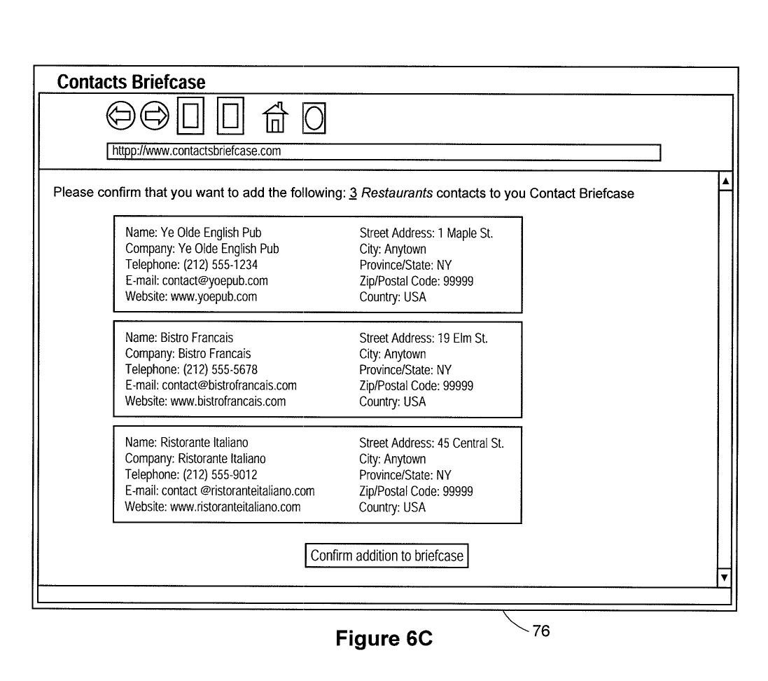

FIG. 6A shows a contacts briefcase browser window 76 having a summary document icon drop zone 78. The contacts briefcase database 22, associated with browser window 76, is preferably a website database at which users can store contact information. In the present example, the user 12 drags summary document icon 60 (see FIG. 4C) from school search browser window 52 to drop zone 78 in browser 76, with the intention of saving school and/or restaurant contacts in the contacts briefcase database 22. Database 22 uploads the summary document associated with icon 60, parses the document, and retrieves all subjects (i.e. real estate homes, restaurants and schools) and their respective identifier URIs (e.g. for home addresses, home listing IDs, restaurant addresses, school addresses). The contacts briefcase database 22 enumerates all unrecognized subject identifiers, places their URIs into a transformation repository mapper input document, which input document is then uploaded to the transformation repository mapper 24. Mapper 24 parses and processes the input document, determining if there exist any mappings between unrecognized home, restaurant and school identifiers on the one hand, and the contact briefcase database's known identifiers on the other hand. For each mapping that is found, a URI to a transformation document is returned, along with the original pairing of unrecognized-to-known identifier. This information is placed in a transformation repository output document that is returned to the contacts briefcase database 22.

Database 22 receives the transformation repository output document, and examines the union of all known identifiers with all unrecognized identifiers that have transformation documents associated with them. The database 22 then creates an enumerated list of possible identifiers to allow for input to the database 22. Based on this list, the database 22 sends back to browser 76 a document containing additional query options for presentation in browser window 76. As shown in FIG. 6B, the contacts briefcase database 22 presents, in the present example, three additional input options in the additional input option zone 80. In the present example, the additional input options are to add real estate homes to the contacts briefcase, to add school catchment area addresses to the contacts briefcase, and to add restaurants to the contacts briefcase. As can be seen in FIG. 6B, the user 12, in this example, has elected only to add restaurants to the contacts briefcase, but not homes or school catchment area addresses.

At the same time as the contacts briefcase database 22 sends to the browser 76 the document containing code to render the new input options, it also sends the required transformation document mappings and transformation document URIs to browser 76. The browser 76 a synchronously receives this information from the contacts briefcase database 22 and parses the response, rendering the new search options in zone 80 of browser 76 as shown in FIG. 6B.

In the present example, transformations are not required for restaurant and school address identifiers, since the contacts briefcase site recognizes all of the address identifiers. The user 12 initiates the addition of entries into the contacts briefcase database 22 by clicking on button 82 shown in FIG. 6B. At this point, the restaurant subjects and identifiers are requested in full from the school search database 18. The school search database 18 returns the requested data, together with a join table. Because the school and home subjects relate, the content of their identifiers is also returned, even though these subjects were not explicitly requested by browser 76. Since the data being requested is the data described in the summary document represented by icon 60, and dragged from the school search database 18, only the restaurants that relate to returned schools (i.e. schools returned in the search of school search database 18) are returned. Non-relating restaurants are not returned.

In an alternate embodiment, the databases 18 and 22, and browser 76, are configured so that only an imperfect subset of the data associated with the relevant restaurants is requested by browser 76 and returned by database 18. The reason is that, in the case of some databases such as a contacts briefcase database, only a limited number of identifiers are relevant. These would - include, in this example, street address, phone number and email address. However, the restaurants may also be identified by identifiers that are completely irrelevant to a contacts briefcase, such as a health inspection file number. As the contacts briefcase 22 is in essence a terminating point in the search, it may be configured, together with browser 76, to request from database 18 only data of the type that is relevant to the contacts briefcase. The feature has the advantage of speeding up the receipt of data, since the amount of data requested is reduced. However, it will be appreciated that full data may be provided by database 18 when requested by browser 76, as described above.

Once this information is received by browser 76 from database 18, the restaurant subjects and associated identifiers, together with the join table, are uploaded to contacts briefcase database 22. The contact briefcase website receives the subject data, including all identifiers, and the join table. The database 22 now adds contact details for the restaurants to the user's list of contacts. A confirmation screen (see FIG. 6C) showing added contacts is returned to browser 76. The user now has the restaurant contacts in his contacts folder stored at the contacts briefcase database 22.

The invention has been described with reference to the illustrative, non-limiting, preferred embodiment. In the preferred embodiment, five databases, together with a method of searching those databases has been described. However, it will be appreciated that the invention comprehends the use of two or more databases. In the example used in this specification to describe the invention, the first database, database 14, is searched, and the search results are used to generate additional query options for searching the second database, database 16. The results of the search of database 16 are used to generate additional query options for searching database 18. The results of the search of database 18 are used to generate additional query/plotting options for database 20, and additional options for saving contacts in database 22.

It will therefore be appreciated that the nature of the additional options generated by each database based on the search results from the previous database will depend not only on the identifiers associated with the search results from the previous database, but also on the functionality of the database that is generating the additional options. So, for example, because database 20 locations entered into the database onto maps, it offers additional query options specifically relating to plotting, such as the option shown in FIG. 5B relating to the plotting of related subjects. Also, because the database 20 can only accept location data for plotting from one source, the preexisting input options are rendered inoperative if one of the additional options is selected.

Despite differences in the specifics of the operation and functionality of different databases, the databases of the present invention are preferably configured to upload a summary document listing subject keys and associated identifiers from the search of a previous database, to parse the document to locate unrecognized identifiers, to obtain available transformation documents for unrecognized identifiers, and to present additional search options based on the recongnized identifiers as well as the unrecognized-but-transformable identifiers. The additional search options preferably allow the user to search for relationships between subjects returned from the search of the previous database, and subjects in the database currently being searched. Once the user 12 selects his search parameters and initiates the search, the browser window preferably requests the returned subjects from the search of the previous database, and uploads them to the database being searched. Search results are then returned, which preferably show relationships between the just-searched database subjects and the subjects returned from the previously-searched database.

Embodiments of and modifications to the described invention that would be obvious to those skilled in the art are intended to be covered by the appended claims. Some variations have been discussed above, and others will be apparent. For example, while the preferred database user interfaces described herein are browsers, other types of database user interfaces are comprehended by the invention.

The embodiments of the invention in which an exclusive property or privilege is claimed are defined as follows:

1. A method of searching a plurality of databases, including a first database and a second database, the method comprising the steps of:
A) querying the first database with a first query;
B) in response to said first query, receiving a summary document from the first database, the summary document comprising a list of returned first database subject keys, representing returned first database subjects, generated by said first query, said list including at least one identifier associated with said returned first database subjects;
C) moving said summary document to the input of a second database, the second database being configured to receive and read said at least one identifier and generate one or more additional query options for querying the second database for relationships, corresponding to said at least one identifier, between second database subjects and said returned first database subjects;
D) querying said second database with at least one of said additional query options, the second database being configured to receive and consume said returned first database subjects;
E) receiving from said second database returned second database subjects, and information relating said returned second database subjects to said returned first database subjects.

2. The method as claimed in claim 1, wherein said step A comprises querying the first database with a first query via a first database user interface, and wherein said step B includes receiving said summary document at said first database user interface in the form of a summary document icon.

3. The method as claimed in claim 2, wherein said input comprises a second database user interface, and wherein said moving step comprises dragging said summary icon from said first database user interface and dropping said summary icon to a drop zone associated with said second database user interface.

4. The method as claimed in claim 1, wherein said step B includes receiving the summary document, the summary document including a definition pointer pointing to a definition of each at least one identifier.

5. The method as claimed in claim 4, wherein said definition pointer comprises a URI.

6. The method as claimed in claim 4, wherein the second database is configured to locate unrecognized identifiers from among said at least one identifier, and to communicate with a transformation mapper to obtain one or more transformation pointers to transformations for rendering said unrecognized identifiers recognizable to said second database.

7. The method as claimed in claim 6, wherein said second database is configured to communicate with said transformation mapper by placing said definition pointers into a transformation mapper input document and uploading said transformation mapper input document to said transformation mapper.

8. The method as claimed in claim 3, wherein said second database is configured to present said query options in said second database user interface to permit a user to select one or more of said additional query options,

9. The method as claimed in claim 3, wherein said information relating said returned second database subjects to said returned first database subjects is provided in the form of hyperlinks associated with the returned second database subjects.

10. A method of searching a second database for second database subjects that relate to returned first database subjects returned from a search of a first database, the method comprising the steps of:
A) receiving a summary document generated by the first database, the summary document comprising a list of returned first database subject keys, representing the returned first database subjects, the list further including at least one identifier associated with the returned first database subjects,
B) reading the summary document and generating one or more second database query options for searching for second database subjects that have relationships to the returned first database subjects corresponding to the at least one identifier;
C) receiving a second database query in accordance with said one or more second database query options;
D) receiving said returned first database subjects;
E) using said returned first database subjects, searching said second database in accordance with said second database query options.

11. The method as claimed in claim 10, further comprising the step of returning returned second database subjects, together with information relating the returned second database subjects to the returned first database subjects.

12. The method as claimed in claim 11, wherein said returning step comprises returning said returned second database subjects, together with information relating the returned second database subjects to the returned first database subjects, in a tabular format.

13. The method as claimed in claim 12, wherein said returning step includes generating a join table relating the returned first database subjects to the returned second database subjects.

14. The method as claimed in claim 10, wherein said step A includes receiving the summary document by uploading the summary document from a second database user interface.

15. The method as claimed in claim 14, wherein the generating step includes sending said second database query options to said second database database user interface.

16. The method as claimed in claim 15, wherein said step C comprises receiving the query via the second database user interface.

17. The method as claimed in claim 14, wherein said step D comprises uploading the returned first database subjects from the second database user interface after said returned first database subjects are downloaded from the first database.

18. The method as claimed in claim 10, wherein the summary document further includes a definition pointer pointing to a definition of each said identifier.

19. The method as claimed in claim 18, wherein the definition pointer comprises a URI.

20. The method as claimed in claim 18, the method further comprising the steps of locating unrecognized identifiers from among said at least one identifier, and communicating with a transformation mapper to obtain one or more transformation pointers to transformations for rendering said unrecognized identifiers recognizable to said second database.

21. The method as claimed in claim 19, wherein said step of communicating with the transformation mapper comprises communicating with said transformation mapper by placing said definitions of said unrecognized identifiers into a transformation mapper input document and uploading said transformation mapper input document to said transformation repository.

22. The method as claimed in claim 21, further comprising the step of receiving from said transformation repository said one or more transformation pointers.

23. The method as claimed in claim 10, wherein said generating step comprises causing said second database query options to be presented in said second database user interface to permit a user to select one or more of said second database query options.

24. The method as claimed in claim 22, wherein said generating step comprises causing said second database query options to be presented in said second database user interface to permit a user to select one or more of said second database query options.

25. A method of conducting a search of a second database that has a second database user interface associated therewith, the method comprising using the second database user interface to perform the steps of:
A) receiving a request from a user to search the second database in accordance with search parameters selected by the user, said search parameters including at least one relationship between subjects returned from a previous search of a first database, and subjects in the second database;
B) requesting the subjects returned from the previous search of the first database;
C) receiving from the first database the subjects returned from the previous search of the first database;
D) uploading to the second database the search parameters, the subjects returned from the search of the first database, and identifiers associated with said subjects, to the second database.
the second database being configured to search in accordance with the search parameters.

26. A method as claimed in claim 25, the method further comprising using the second database user interface to perform the steps of requesting one or more transformation documents, for transforming one or more subject identifiers from the first database that are unrecognized by the second database, from at least one transformation document repository, and receiving said transformation documents.

27. A method as claimed in claim 26, the method comprising using the second database user interface to perform the steps of applying the one or more transformation documents to the one or more unrecognized identifiers to create one or more transformed identifiers, and uploading the one or more transformed identifiers to the second database.
